(19) United States
(12) Patent Application Publication
(10) Pub. No.: US 2026/0120025 A1
(43) Pub. Date: Apr. 30, 2026

(54) SYSTEM AND METHOD FOR OPERATING AN ARTIFICIAL INTELLIGENCE (AI) WORKBENCH

(71) Applicant: Raft LLC, McLean, VA (US)

(72) Inventors: Jacob Tyo, Morgantown, WV (US); Sean Higgins, Nampa, ID (US); Bhaarat Sharma, Vienna, VA (US)

(21) Appl. No.: 19/375,662

(22) Filed: Oct. 31, 2025

Related U.S. Application Data
(60) Provisional application No. 63/714,483, filed on Oct. 31, 2024.

(51) Int. Cl. G06Q 10/0631; G06F 8/34; G06F 9/451

(52) U.S. Cl. CPC G06Q 10/06316; G06F 8/34

(57) ABSTRACT

A system and method for operating an artificial intelligence (AI) workbench is provided. The method executed on a computing device may include enabling a user, via an AI workbench, to create an AI workflow and converting the AI workflow into an executable computational representation. The method may further include performing data collection, data processing, and data analysis for the AI workflow, developing one or more visualization tools for the AI workflow, and developing a UI for the AI workflow. The method may also include selecting one or more machine-learning (ML) models to be used in the AI workflow, and developing a set of rules for interpreting results generated for each ML model of the one or more selected ML models.

### CROSS-REFERENCE TO RELATED APPLICATIONS

This application claims the benefit of U.S. provisional application 63/714,483, which was filed on Oct. 31, 2024, the contents of which are hereby incorporated by reference in its entirety.

### DISCUSSION OF THE RELATED ART

AI workflows typically follow a structured pipeline that may combine data acquisition, preprocessing, model development, evaluation, and deployment. Advances in automation, MLOps (Machine Learning Operations), and tools for scalability have shaped modern AI workflows. Currently, the key stages of AI workflows may include: (i) data collection and preparation, (ii) model development, (iii) model training, (iv) model evaluation and validation, (v) model deployment, (vi) monitoring and maintenance, and (vii) governance, ethics, and security. Recent development trends for AI workflows may include generative AI models for content generation and code assistance, zero-shot/few-shot learning for generalizing tasks with little or no task-specific data, and pre-built AI in the cloud services for speech recognition, computer vision, and numerous other applications.

### SUMMARY OF DISCLOSURE

In one example implementation, a computer-implemented method executed on a computing device may include enabling a user, via an AI workbench, to create an AI workflow, and converting the AI workflow into an executable computational representation. The method may further include performing data collection, data processing, and data analysis for the AI workflow, developing one or more visualization tools for the AI workflow, and developing a UI for the AI workflow. The method may also include selecting one or more machine-learning (ML) models to be used in the AI workflow, and developing a set of rules for interpreting results generated for each ML model of the one or more selected ML models.

One or more of the following example features may be included. The AI workbench may be a full-stack platform configured to provide end-to-end functionality from a front-end user interface to a back-end combination of infrastructure and programming logic. The AI workbench may include a no-code user interface (UI) configured to allow users without coding skills to produce customized AI tools, and to perform rapid prototyping without software development cycles. The no-code UI may include a workflow canvas configured to allow users to select and reorganize one or more modular components when creating the AI workflow, and a natural language programming (NLP) interface configured to receive and translate user-generated text-based, non-coded instructions defining a set of operational behaviors for each modular component of the one or more modular components selected for the AI workflow into machine-executable code-based instructions. The one or more modular components may be selected from a set of different component types, wherein the set of different component types includes at least: a data input component configured to receive input data, a pre-processing component configured to clean, reformat, encrypt, or transform input data, a model component configured to run one ML model from a set of different ML models, a logic-control component configured to implement one or more logic commands, including at least if-else statements, filtering, branching, and looping, a data output component configured to send output data to one output format from a set of different output formats, a visualization component configured to display intermediate results or final results in one display format from a set of different display formats, an annotation component configured to allow users to manually enter or modify labels or results, and a monitoring component configured to collect and display performance metrics in one display format from the set of different display formats. The NLP interface may include one or more large language models (LLMs) trained in a wide variety of topics, including at least: machine learning concepts, model application programming interfaces (APIs), data transformations, data serialization formats, and workflow schema templates. The workflow canvas may include a debugging window configured to provide oversight of every step of the information flow through the AI workflow, and a live-preview window configured to provide real-time rendering of the AI workflow while user changes are actively being made on the workflow canvas. The AI workbench may include a machine-learning operations (MLOps) unit configured to: deploy ML models selected for the AI workflow, trigger model retraining for ML models selected for the AI workflow, monitor and report on performance metrics for the AI workflow, and perform versioning and generate audit trails for the AI workflow. The method may further include deploying the one or more selected ML models, via the MLOps unit, in a network environment, retraining the one or more ML models previously deployed in the AI workflow, and reintegrating the retrained ML models into the AI workflow. The AI workbench may be configured to be scalably deployed in a plurality of network environments, including at least: cloud networks, on-premises networks, and edge-computing networks. The AI workflow may include an AI-powered assistant configured to recommend templates, provide contextual help, make suggestions, and guard against common misconceptions held by users when implementing machine learning processes.

In another example implementation, a computer program product residing on a non-transitory computer readable medium having a plurality of instructions stored thereon which, when executed by a processor, may cause the processor to perform operations including: enabling a user, via an artificial intelligence (AI) workbench, to create an AI workflow, converting the AI workflow into an executable computational representation, and developing one or more visualization tools for the AI workflow. Further operations performed by the processor may include developing a UI for the AI workflow, enabling a user, via the AI workbench, to select one or more machine-learning (ML) models to be used in the AI workflow, and developing a set of rules for interpreting results generated for each ML model of the one or more selected ML models.

One or more of the following example features may be included. The AI workbench may be a full-stack platform configured to provide end-to-end functionality from a front-end user interface to a back-end combination of infrastructure and programming logic. The AI workbench may include a no-code user interface (UI) configured to allow users without coding skills to produce customized AI tools, and to perform rapid prototyping without software development cycles. The no-code UI may include: a workflow canvas configured to allow users to select and reorganize one or more modular components when creating the AI workflow, and a natural language programming (NLP) interface configured to receive and translate user-generated text-based, non-coded instructions defining a set of operational behaviors for each modular component of the one or more modular components selected for the AI workflow into machine-executable code-based instructions.

In another example implementation, an artificial intelligence (AI) workbench system hosted on one or more servers connected to a scalable network, may include a no-code user interface (UI) configured to allow users without coding skills to produce customized artificial intelligence (AI) tools, and to perform rapid prototyping without software development cycles. The AI workbench system may further include a machine-learning operations (MLOps) unit configured to: deploy ML models selected for the AI workflow, trigger model retraining for ML models selected for the AI workflow, monitor and report on performance metrics for the AI workflow, and perform versioning and generate audit trails for the AI workflow.

One or more of the following example features may be included. The no-code UI may include: a workflow canvas configured to allow users to select and reorganize one or more modular components when creating the AI workflow, and a natural language programming (NLP) interface configured to receive and translate user-generated text-based, non-coded instructions defining a set of operational behaviors for each modular component of the one or more modular components selected for the AI workflow into machine-executable code-based instructions. The one or more modular components may be selected from a set of different component types, wherein the set of different component types may include at least: a data input component configured to receive input data, a pre-processing component configured to clean, reformat, encrypt, or transform input data, a model component configured to run one ML model from a set of different ML models, a logic-control component configured to implement one or more logic commands, including at least if-else statements, filtering, branching, and looping, a data output component configured to send output data to one output format from a set of different output formats, a visualization component configured to display intermediate results or final results in one display format from a set of different display formats, an annotation component configured to allow users to manually enter or modify labels or results, and a monitoring component configured to collect and display performance metrics in one display format from the set of different display formats. The NLP interface may include one or more large language models (LLMs) trained in a wide variety of topics, including at least: machine learning concepts, model application programming interfaces (APIs), data transformations, data serialization formats, and workflow schema templates. The AI workbench system may further include an AI-powered assistant configured to recommend templates, provide contextual help, make suggestions, and guard against common misconceptions held by users when implementing machine learning processes.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 diagrammatically depicts a management process coupled to a distributed computing network consistent with embodiments of the present disclosure;

FIG. 2A shows a block diagram of an AI workbench consistent with embodiments of the present disclosure;

FIG. 2B shows a logical diagram of an MLOps layer consistent with embodiments of the present disclosure;

FIG. 2C shows an example of an AI assistant in use in a GUI consistent with embodiments of the present disclosure;

FIG. 3A shows an example of a “no-code” AI workflow interface consistent with embodiments of the present disclosure;

FIG. 3B shows an example of a “no-code” AI workflow in use in a GUI consistent with embodiments of the present disclosure;

FIG. 4 shows an example of a “no-code” AI workflow interface using natural language programming consistent with embodiments of the present disclosure;

FIG. 5 shows an example of a resource management page of an AI workflow interface consistent with embodiments of the present disclosure; and

FIG. 6 shows a flowchart of a component creation and deployment process for an AI workflow consistent with embodiments of the present disclosure.

### DETAILED DESCRIPTION

The AI (artificial intelligence) workbench described herein may be an innovative platform that revolutionizes the creation, deployment, and management of complex AI workflows. The AI workbench may combine an intuitive, no-code user interface with a powerful MLOps backend to democratize AI development and empower non-technical users to harness the full potential of artificial intelligence. The system primarily consists of two main components: (i) a user interface and (ii) an MLOps (machine learning operations) backend.

The AI Workbench may be a full-stack platform for creating, deploying, managing, and scaling AI workflows without requiring coding expertise. A full-stack platform may refer to a system that provides end-to-end functionality across all layers of an application, starting from a user interface (front end) to a combination of infrastructure and processing logic (back end). In simpler terms, a full-stack platform may handle everything needed to build, run, and manage an application.

Reference will now be made in detail to the embodiments of the present disclosure, examples of which are illustrated in the accompanying drawings. The present disclosure may, however, be embodied in many different forms and should not be construed as being limited to the embodiments set forth herein. Rather, these embodiments are provided so that this disclosure will be thorough and complete, and will fully convey the concept of the disclosure to those skilled in the art.

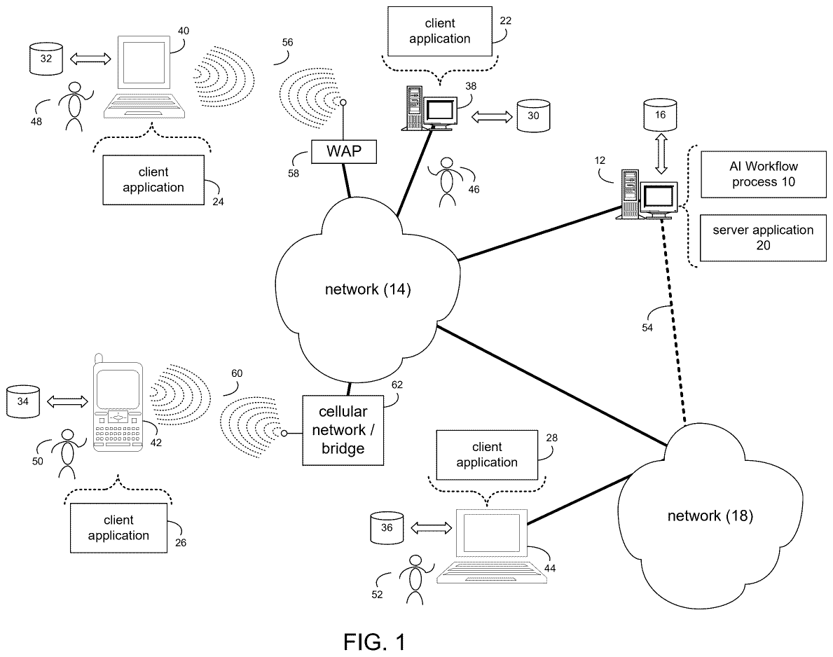

Referring to FIG. 1, there is shown an AI workflow process 10 that may reside on and may be executed by server computer 12, which may be connected to network 14 (e.g., the internet or a local area network). Examples of server computer 12 may include, but are not limited to: a personal computer, a server computer, a series of server computers, a minicomputer, and a mainframe computer. Server computer 12 may be a web server (or a series of servers) running a network operating system, examples of which may include but are not limited to: Microsoft Windows XP Server™; Novell Netware™; or Redhat Linux™, for example. Additionally, and/or alternatively, AI workflow process 10 may reside on a client electronic device, such as a personal computer, notebook computer, personal digital assistant, or the like.

The instruction sets and subroutines of the AI workflow process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, which allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more server applications (e.g., server application 20), examples of which may include but are not limited to, e.g., Microsoft Exchange™ Server, etc. Server application 20 may interact with one or more client applications (e.g., client applications 22, 24, 26, 28) in order to execute AI workflow process 10. Examples of client applications 22, 24, 26, 28 may include, but are not limited to, EDAs or design verification tools such as those available from the assignee of the present disclosure. These applications may also be executed by server computer 12. In some embodiments, AI workflow process 10 may be a stand-alone application that interfaces with server application 20 or may be applets / applications that may be executed within server application 20.

The instruction sets and subroutines of server application 20, which may be stored on storage device 16 coupled to server computer 12, may be executed by one or more processors (not shown) and one or more memory architectures (not shown) incorporated into server computer 12.

As mentioned above, in addition, or as an alternative to being server-based applications residing on server computer 12, AI workflow process 10 may be a client-side application residing on one or more client electronic devices 38, 40, 42, 44 (e.g., stored on storage devices 30, 32, 34, 36, respectively). As such, AI workflow process 10 may be a stand-alone application that interfaces with a client application (e.g., client applications 22, 24, 26, 28), or may be applets/applications that may be executed within a client application. As such, AI workflow process 10 may be a client-side process, server-side process, or hybrid client-side/server-side process, which may be executed, in whole or in part, by server computer 12, or one or more of client electronic devices 38, 40, 42, 44.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using client applications 22, 24, 26, 28, users 46, 48, 50, 52 may utilize the EDA to create an electronic design.

Users 46, 48, 50, 52 may access server application 20 directly through the device on which the client application (e.g., client applications 22, 24, 26, 28) is executed, namely client electronic devices 38, 40, 42, 44, for example. Users 46, 48, 50, 52 may access server application 20 directly through network 14 or through secondary network 18. Further, server computer 12 (e.g., the computer that executes server application 20) may be connected to network 14 through secondary network 18, as illustrated with phantom link line 54.

In some embodiments, AI workflow process 10 may be a cloud-based process as any or all of the operations described herein may occur, in whole, or in part, in the cloud or as part of a cloud-based system. The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (CSMA/CA) for path sharing. The various 802.11x specifications may use phase-shift keying (PSK) modulation or complementary code keying (CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, Apple iOS, ANDROID, or a custom operating system.

In some embodiments, AI workflow process 10 may include any or all of the operations and features included herein.

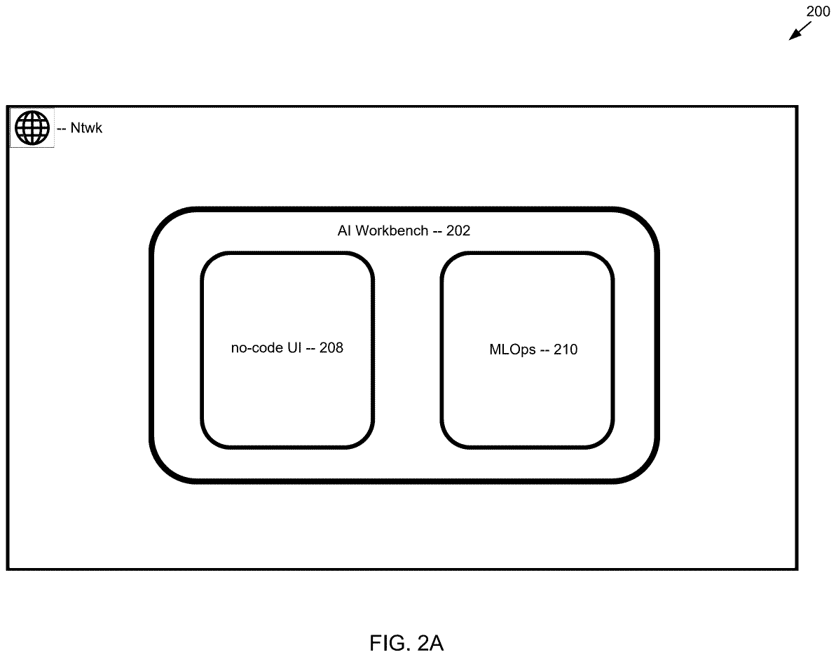

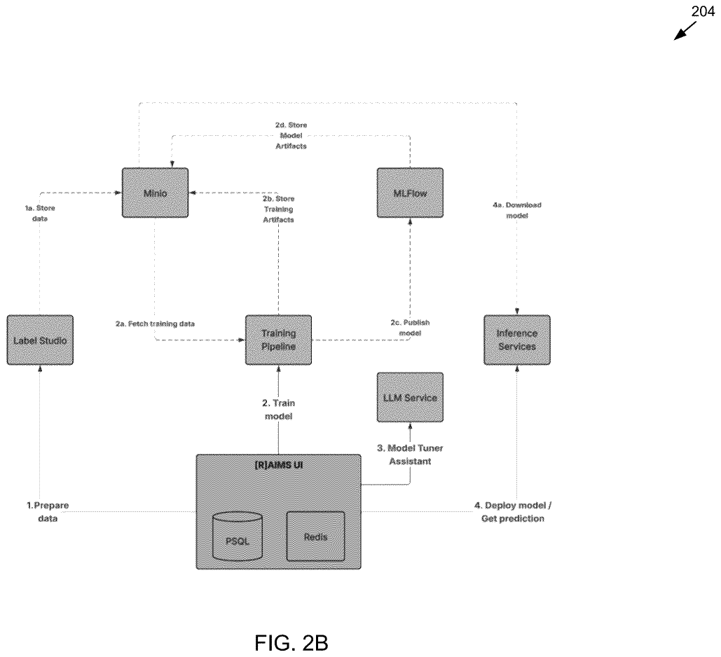

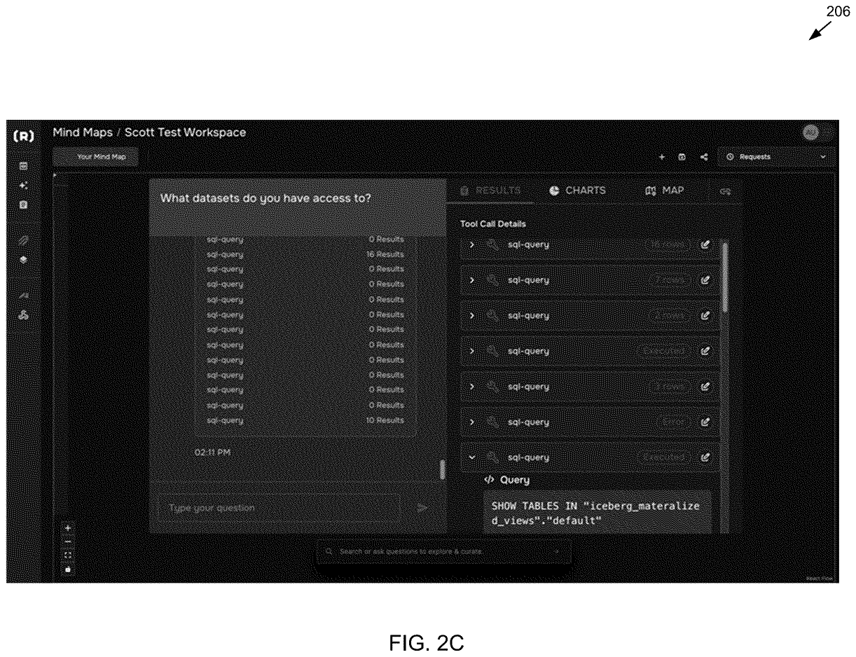

Referring now to FIGS. 2A-2C, block diagram 200 of AI workbench 202, logic diagram 204 of a machine learning operations (MLOps) layer, and example graphical user-interface (GUI) 206 of an AI assistant in use consistent with embodiments of the present disclosure are provided. As previously mentioned, AI workbench 202 may be a full-stack platform because it provides a front-end for non-technical users as well as a backend for model training, versioning, and scaling. The front-end may refer to a user interface (UI) configured to provide a visual, drag-and-drop environment for creating AI workflows without the need to write any coded instructions (e.g., no-code UI 208). The back-end may refer to an infrastructure layer that automates and manages operations for the entire machine learning lifecycle behind the scenes (e.g., MLOps 210). Once a user designs a workflow in no-code UI 208, MLOps 210 may translate the workflow graph into executable pipelines, provision the necessary compute resources (e.g., CPUs, GPUs, or containers), and orchestrate the flow of data and models. “Pipelines”, in this context, may refer to a linear, automated sequence of machine-executable steps happening behind the scenes (e.g., ingest→clean→train→deploy), as opposed to “workflows,” which may refer to the broader, more interactive frontend process.

In some embodiments, MLOps 210 may be installed on the same server as no-code UI 208. MLOps 210 may also be installed on a central server by itself, such that one or more secondary servers with additional computing power may be connected to the central server. Logic diagram 204 of the MLOps layer may show where each secondary server may be dedicated to a specific function, while being connected to a central server.

In some embodiments, the full-stack platform of AI workbench 200 may be installed on one or more servers deployed in a network environment (e.g., Ntwk), however the size and nature of the deployment may depend on the needs or goals of the user. In some embodiments, the Ntwk may be a cloud environment, in other embodiments, it may be an on-premises network. In further embodiments, AI workbench 200 may be deployed in an edge network. As such, AI workbench 200 may allow for scalable deployments across network environments of differing size and nature. More specifically, the scalability of AI workbench 200 may be achieved through a modular, cloud-native architecture that supports horizontal scaling, flexible deployment environments, and resource orchestration, which may be discussed in greater detail below.

In some embodiments, scaling may happen based on a configurable load metric. The choice between computer processing unit (CPU) load, graphical processing unit (GPU) load, memory pressure, and disk pressure may be possible. Scaling limits may be configured based on the maximum number of computer nodes each process may consume, and then set to a default minimum value. Once the selected load metric threshold is reached, another computer node may be assigned a duplicate task, and requests may be routed in priority order between the deployments of the same service to enable controlled downscaling. Once usage drops below a configurable threshold, then the computer nodes may be released.

In some embodiments, MLOps 210 may translate the user-created workflow into executable pipelines, provision the necessary compute resources (e.g., CPUs, GPUs, or containers), and orchestrate the flow of data and models. MLOps 210 may continuously monitor model performance, track data drift, manage experiment metadata (such as hyperparameters and evaluation metrics), and may trigger automated ML model retraining when thresholds are breached. Additionally, MLOps 210 may ensure reproducibility through model versioning and supports scalable deployment across cloud, on-premises, or edge environments. As a back-end, MLOps 210 may serve as the operational core that enables non-technical users to build and maintain production-grade AI systems with minimal friction.

In some embodiments, AI workbench 200 may include an AI-powered assistant integrated into the no-code UI 208 to provide contextual help to users as they build their workflows, for example, the assistant may provide templates based on a description during the initial workflow creation, offer recommendations for workflow improvements, or explain the purpose of different components, and help troubleshoot issues. The AI assistant may be an expert in all underlying technology, providing the means by which the platform interaction follows. Instead of having to build workflows in painstaking manual steps, a user may dictate to the AI agent the desired goal to get a prototype, as shown in GUI 206 of FIG. 2C. Furthermore, the AI assistant may continually iterate on the workflow, using tools throughout the system to build on behalf of the end user.

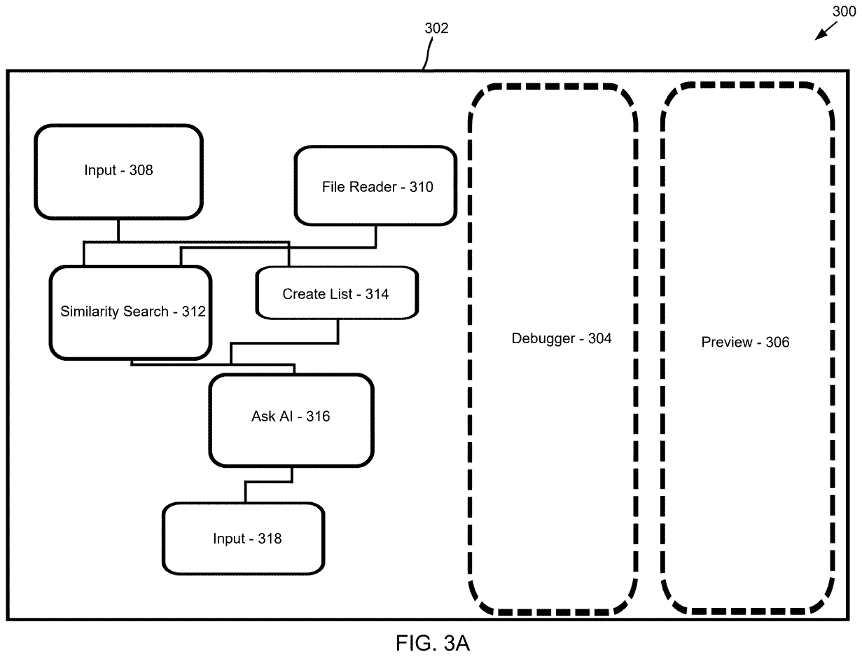

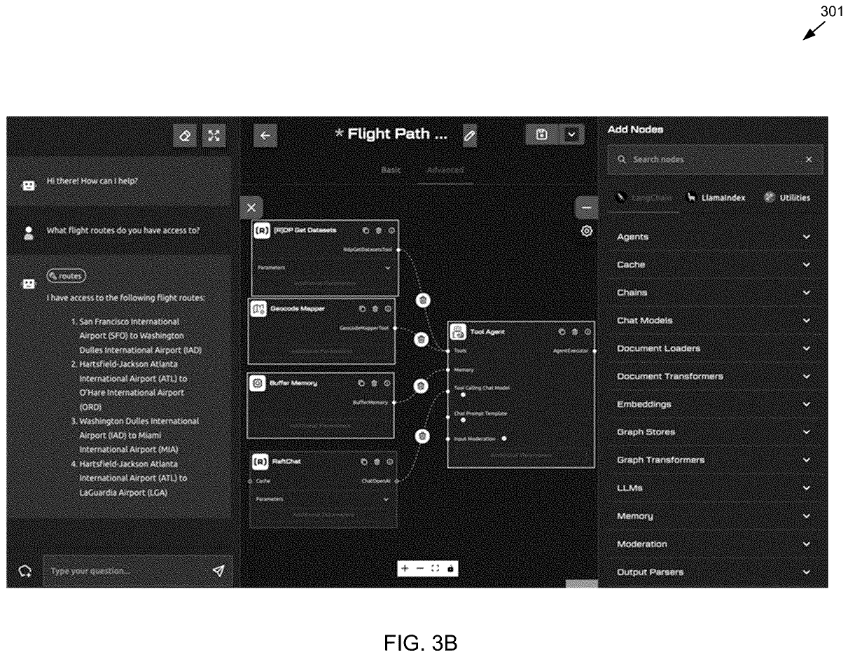

Referring now to FIGS. 3A-3B, a logical representation of a “no-code” AI workflow interface (e.g., no-code UI 300) and screenshot of the no-code UI in use (e.g., screenshot 301) consistent with embodiments of the present disclosure are provided. No-code UI 300 may represent the building of a retrieval augmented generation system powered by state-of-the-art AI systems. No-code UI 300 may include a drag-and-drop workflow canvas (e.g., canvas 302), which may be used to intuitively build a workflow and describe what each block should do. No-code UI 300 may also include an explainable debugging window (e.g., debugger 304) that may offer transparency by providing deep visibility into each step of the workflow, as well as a live preview (e.g., preview 306) of the resulting application or workflow. Screenshot 301 may give an idea of the end-user experience when using the no-code UI in an application or web-browser.

In some embodiments, when working in canvas 302, users may select from a library of pre-built components (e.g., blocks 308, 310, 312, 314, 316, 318), and connect them to form complete workflows of arbitrary complexity and originality. The library may include a wide variety of component types including but not limited to: (i) a data input component configured to receive input data, (ii) a pre-processing component configured to clean, reformat, encrypt, or transform input data, (iii) a model component configured to run one ML model from a set of different ML models, (iv) a logic-control component configured to implement one or more logic commands, including at least if-else statements, filtering, branching, and looping, (v) a data output component configured to send output data to one output format from a set of different output formats, (vi) a visualization component configured to display intermediate results or final results in one display format from a set of different display formats, (vii) an annotation component configured to allow users to manually enter or modify labels or results, and (viii) a monitoring component configured to collect and display performance metrics in one display format from the set of different display formats.

The library may include components related to credentials, such as: authentication and API credentials for various services. The library may include components related to AI/ML services, such as: AnthropicApi, AzureOpenAIApi, OpenAIApi, OpenAICustom, GoogleAuth, GoogleGenerativeAI, GoogleMakerSuite, HuggingFaceApi, MistralApi, CohereApi, GroqApi, LocalAIApi, OllamaApi, CerebrasApi, TogetherAIApi, ReplicateApi, ScaleAIApi, and NIPRGPTApi. The library may include components related to cloud providers, such as: AWSCredential, AzureOpenAIApi, GoogleAuth, and GoogleSearchApi. The library may include components related to vector databases & search, such as: PineconeApi, QdrantApi, WeaviateApi, ChromaApi, MilvusAuth, VectaraApi, UpstashVectorApi, ElasticsearchAPI, OpenSearchUrl, and MeilisearchApi. The library may include components related to databases, such as: PostgresApi, PostgresUrl, MySQLApi, MongoDBUrlApi, CouchbaseApi, SingleStoreApi, DynamodbMemoryApi, RedisCacheApi, RedisCacheUrlApi, and UpstashRedisApi. The library may include components related to analytics & monitoring, such as: LangfuseApi, LangsmithApi, LangWatchApi, and LunaryApi. The library may include components related to specialized services, such as: NotionApi, ConfluenceCloudApi, ConfluenceServerDCApi, SharepointApi, SlackApi, GithubApi, FigmaApi, ApifyApi, SpiderApi, FireCrawlApi, UnstructuredApi, AssemblyAI, E2B, ComposioApi, StripeApi, BraveSearchApi, ExaSearchApi, SerperApi, SerpApi, MapboxApi, LabelStudio, and RaftKubeflow.

In some embodiments, the library may include components related to agents, such as ConversationalAgent (basic conversational AI agent), ReActAgentChat (ReAct pattern for chat models), ReActAgentLLM (ReAct pattern for LLM models), ToolAgent (Agent with tool calling capabilities), and XMLAgent (XML-based agent interactions). The library may include components related to specialized agents, such as: AutoGPT (autonomous GPT agent), BabyAGI (task-driven autonomous agent), CSVAgent (agent for CSV data processing), ConversationalRetrievalToolAgent (RAG+tools agent), OpenAIAssistant (OpenAI Assistant API integration), LlamaIndex agents, AnthropicAgent_LlamaIndex (anthropic integration), OpenAIToolAgent_LlamaIndex (OpenAI tool agent). The library may include components related to chains, such as: API Chains, GETApiChain (GET API requests), POSTApiChain (POST API requests), and OpenAPIChain (OpenAPI specification based). The library may include components related to quality and assurance (Q&A) chains, such as: ConversationalRetrievalQAChain (Conversational RAG), RetrievalQAChain (basic RAG chain), MultiRetrievalQAChain (multiple retriever RAG), VectorDBQAChain (vector database Q&A), and GraphCypherQAChain (graph database queries). The library may include components related to core chains, such as: LLMChain (basic LLM chain), ConversationChain (conversation management), MultiPromptChain (multiple prompt routing), and ImageChain (image processing chain). The library may include components related to specialized chains, such as: SqlDatabaseChain (SQL database interactions), ATOChain (authority to operate processing), PolicyEditorChain (policy editing workflows), RaftObdaEditorChain (OBDA editor), RaftSparqlQueryChain (SPARQL queries), and RaftSqlQueryChain (SQL queries).

In some embodiments, the library may include components related to chat models, such as: ChatOpenAI (standard OpenAI chat models), ChatOpenAICustom (custom OpenAI endpoints), AzureChatOpenAI (Azure OpenAI service), ChatOpenAI_LlamaIndex (LlamaIndex integration), ChatAnthropic (Claude models), FlowiseChatAnthropic (Flowise integration), ChatAnthropic_LlamaIndex (LlamaIndex integration), ChatGoogleGenerativeAI (Gemini models), ChatGooglePaLM (PaLM models), ChatGoogleVertexAI (Vertex AI models), ChatHuggingFace (Hugging Face models), ChatMistral (Mistral AI models), ChatOllama (Local Ollama models), Groq (Groq inference), ChatLocalAI (local AI models), ChatCerebras (Cerebras systems), ChatScaleAI (scale AI models), ChatNIPRGPT (NIPR GPT models), and RaftChat (Raft's custom chat models). The library may include components related to document loaders, such as: file types, file (generic file loader), text/plain text (text files), PDF (PDF documents), Docx (Microsoft Word documents), MicrosoftPowerpoint (PowerPoint presentations), CSV files, Json/Jsonlines (JSON data), MicrosoftWord (word documents), Cheerio (web scraping), API (API endpoints), Gitbook (GitBook documentation), Github (GitHub repositories), Spider (web crawling), S3File/S3Directory (Amazon S3), Folder/DirectoryLoader (local directories), Confluence (Confluence pages), Sharepoint (SharePoint documents), DocumentStore (document store integration), CustomDocumentLoader (Custom implementations), FormExtractor (form data extraction), Unstructured (Unstructured.io integration), and VectorStoreToDocument (vector store as documents).

In some embodiments, the library may include components related to embeddings, such as: OpenAIEmbedding, OpenAIEmbeddingCustom, AzureOpenAI Embedding, OpenAIEmbedding_LlamaIndex, GoogleGenerativeAI Embedding, GooglePaLM Embedding, GoogleVertexAI Embedding, HuggingFaceInference Embedding, MistralEmbedding, Ollama Embedding, LocalAI Embedding, VoyageAI Embedding, ScaleAIEmbedding, RaftEmbedding, and AWSBedrockEmbedding. The library may include components related to tools, such as: Core Tools, Calculator, CustomTool, ChainTool, ChatflowTool, GoogleSearchAPI, RaftWebSearch, ReadFile, WriteFile, RequestsGet/RequestsPost, OpenAPIToolkit, CodeInterpreterE2B, WebBrowser, CreateChart, GeocodeMappe, MapboxGeocodeTool, PlotPoints, CustomMCP, where MCP refers to Model Context Protocol, GithubMCP, PostgreSQLMCP, SequentialThinkingMCP, CurrentDateTime, RetrieverTool, QueryEngineTool, RouteFlightsTool, MarketResearchGetSection/UpdateSection, OpenDeepResearch, and RDP Tools. The library may include components related to vector stores such as: Chroma, Pinecone, Qdrant, Weaviate, Milvus, Postgres, MongoDBAtlas, Redis, Supabase, OpenSearch, InMemory, SimpleStore, DocumentStoreVS, and Zep/ZepCloud. The library may include components related to memory, such as: Buffer Memory, BufferWindowMemory, ConversationSummary Memory, ConversationSummary Buffer Memory, RedisBackedChatMemory, MongoDBMemory, DynamoDb, ZepMemory/ZepMemoryCloud, and AgentMemory.

In some embodiments, the library may include components related to retrievers, such as: VectorStoreRetriever, MultiQueryRetriever, HydeRetriever, SimilarityThreshold Retriever, Custom Retriever, Prompt Retriever, LLMFilter Retriever, EmbeddingsFilterRetriever, RRFRetriever, and AWSBedrockKBRetriever. The library may include components related to text splitters, such as: CharacterTextSplitter, RecursiveCharacterTextSplitter, TokenTextSplitter, MarkdownTextSplitter, CodeTextSplitter, and HtmlToMarkdownTextSplitter. The library may include components related to sequential agents, such as: Start/End (flow control nodes), Agent (basic sequential agent), LLMNode, ToolNode, State management, Condition/ConditionAgent, Loop control, CustomFunction, ExecuteFlow, DocAgent, FormAgent, HNITAgent, ListAgent, and LongAgent. The library may include components related to analytics, such as: LangFuse integration, LangSmith integration, LangWatch integration, and Lunary integration. The library may include components related to caches, such as InMemoryCache, RedisCache, and MomentoCache. The library may include components related to LLMs, such as: OpenAI, AWSBedrock, Azure OpenAI, GooglePaLM/GoogleVertexAI, HuggingFaceInference, Ollama, and RaftLLM. The library may include components related to Output Parsers, such as: StructuredOutputParser, StructuredOutputParser Advanced, CSVListOutputParser, and CustomListOutputParser. The library may include components related to prompts, such as: PromptTemplate, ChatPromptTemplate, FewShotPromptTemplate, and PromptLangfuse. The library may include components related to document transformers, such as: ATOParser, and DocToText. The library may include components related to engines, such as: QueryEngine, ChatEngine, and SubQuestionQueryEngine.

In some embodiments, the library may include components related to graphs like Neo4j graph database integration. The library may include components related to graph transformers, such as: LangchainNeo4j, and RaftSynthesis. The library may include components related to moderation, such as OpenAIModeration, and SimplePromptModeration. The library may include components related to Multi-Agents, such as Supervisor (Multi-agent supervisor), Worker (Multi-agent worker), and Long Worker (Long-running worker). The library may include components related to Record Manager, such as PostgresRecordManager. The library may include components related to Response Synthesizers, such as: SimpleResponseBuilder, Refine, CompactRefine, and TreeSummarize. The library may include components related to Speech to Text, like AssemblyAI. The library may include components related to Utilities, such as: CustomFunction, GetVariable/SetVariable, IfElseFunction, and StickyNote.

In some embodiments, debugger 304 may function as an interactive, visual inspection tool that may help users understand, validate, and troubleshoot the AI workflows that they may be in the process of creating in real-time, or in post-execution, all without needing to write code or inspect raw logs. Debugger 304 may provide users with a level of transparency that may provide insight into the inner workings of each workflow block, and error detection capabilities that may highlight misconfigurations, missing inputs, or failed executions. Debugger 304 may also provide non-technical users with a step-by-step understanding of how data flows and transforms through an AI workflow. Further, debugger 304 may also provide performance statistics for each step (e.g., latency, memory usage), so that the AI workflow may be optimized for its intended purpose.

In some embodiments, the bones of the platform may provide full granularity of every action, request, response, and trigger, such that everything may be logged to an event bus. The debugger may tie into that event bus, and provide a visualization and analysis layer on top of it, which may include timeline ghantt views of every AI action, call, and step in all workflows.

In some embodiments, preview 306 may serve as a real-time visual rendering of the AI workflow being created/edited by the user, thereby enabling users to see the end result of their pipeline as they build or modify it. Preview 306 may bridge the gap between workflow construction and application output, allowing immediate feedback and iteration. More specifically, preview 306 may provide immediate feedback to show what the AI application or workflow currently does, as well as visual confirmation that the outputs of the workflow (text, images, predictions, etc.) match expectations. Preview 306 may also provide interactive testing that may allow users to run sample input values through the AI workflow to observe how output values change. The interactive testing may also provide rapid prototyping of numerous iterations without full deployment or a complete software development cycle.

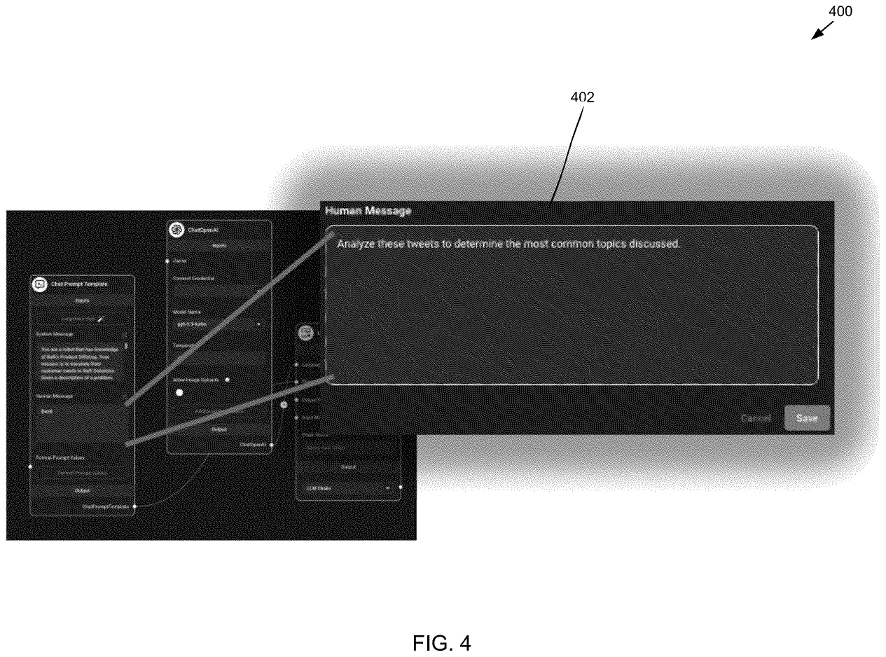

Referring now to FIG. 4, an example of a “no-code” AI workflow interface (e.g., no-code 400) using natural language programming (NLP) consistent with embodiments of the present disclosure is provided. The NLP capability may allow for each block within a workflow to be “programmed” using plain language instructions. No-code UI 400 may provide an NLP interface (e.g., NLP 402) for users to enter instructions for the AI workflow. These instructions need not be code-based or technical in nature. Simple conversational language may be received and interpreted by no-code UI 400 through the use of the NLP 402 to translate the user-generated text-based, non-coded instructions that may define a set of operational behaviors for each modular component selected for the AI workflow (e.g., blocks 308, 310, 312, 314, 316, 318), into machine-executable code-based instructions. As such, non-technical users may be empowered to customize the behavior of individual components without prior knowledge or experience with writing code. For example, a user may instruct a language model block to “summarize the input text in bullet points” or tell an image processing block to “detect and highlight faces in the input image.”

In some embodiments, no-code UI 300 may seamlessly integrate various types of AI models, including large language models (LLMs) for text processing, computer vision models for image and video analysis, and custom models for specific domain tasks. Users may easily incorporate these models into their workflows and chain them together to create more sophisticated AI applications. Further, in terms of text processing ability, NLP 402 may use one or more LLMs trained in a wide variety of topics, including but not limited to: (i)machine learning concepts, (ii) model application programming interfaces (APIs), (iii) data transformations, (iv) data serialization formats, and (v) workflow schema templates. As a result, NLP 402 may be better equipped to translate the plain language instructions entered by the user into machine-executable code-based instructions. Note that there may be intermediate pseudo-code language developed as token efficient and rich descriptors of the platform, that may be parsed algorithmically into actions. The role of the AI system may be to translate from raw and loose English into that pseudo-code language. Furthermore, the system may use semantic similarities at the moment of embedding to be able to ensure mappings into valid pseudo code via a context-free grammar, implemented at the embedding layer instead of on output tokens.

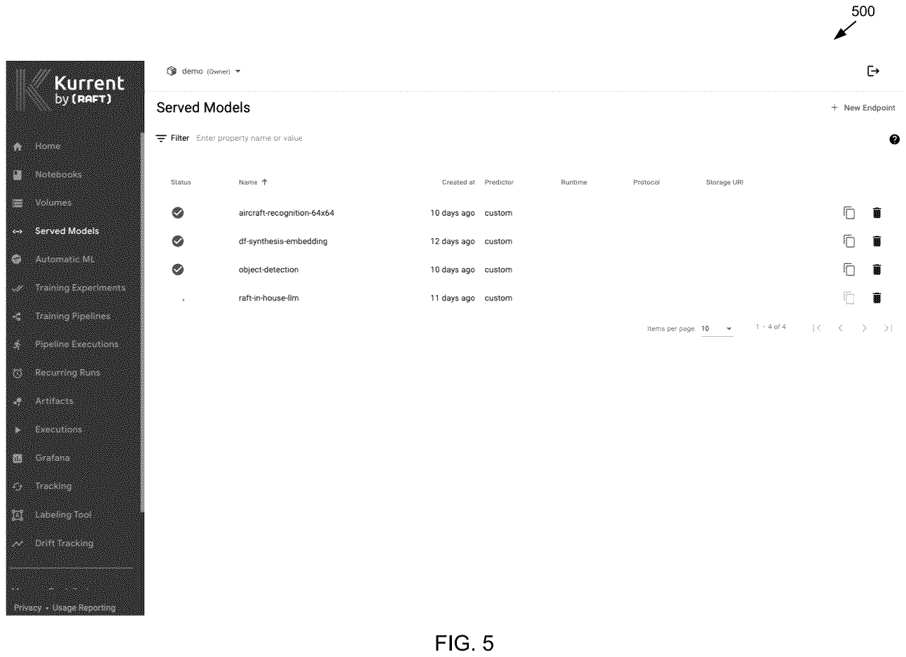

Referring now to FIG. 5, example 500 of a resource management page for a “no-code” AI workflow interface, consistent with embodiments of the present disclosure, is provided. The resource management page of no-code UI may provide users with clear visibility into the resource costs and performance metrics of their AI workflows. This may include CPU/GPU usage, memory consumption, interference times, and associated cloud costs, allowing users to optimize their applications for efficiency and cost-effectiveness. Example 500 may also show various types of AI models being incorporated into the AI workflow, currently being created/edited, like the “aircraft-recognition-64×64” model that may be used to perform aircraft path prediction. The user may obtain an AI model, fully developed elsewhere, and incorporate it into the AI workflow after the fact. The resource management page may provide insight into both high level metrics at the scale of the total computer resources used, or the metrics for how an individual computer unit may be performing.

In some embodiments, the no-code UI may further include a simplified interface for retraining AI models, allowing non-technical users to upload new training data to update the knowledge base or behaviors of an AI model, all without requiring an understanding of the intricacies of machine learning algorithms. More specifically, non-technical users may upload new training data, label examples through an intuitive UI, and initiate the retraining process. The MLOps backend may handle the complexities of data preprocessing, model fine-tuning, and performance evaluation.

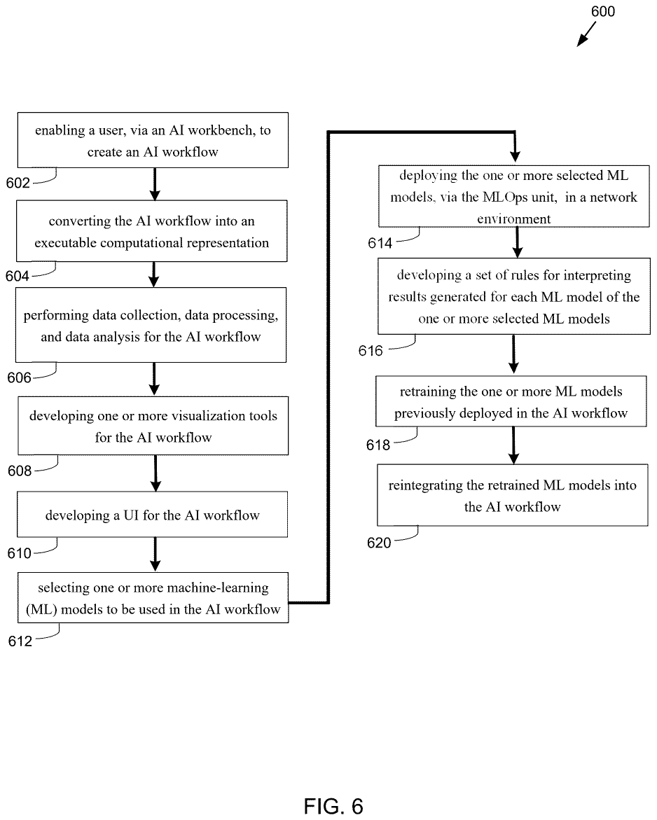

Referring now to FIG. 6, a flowchart of a component creation and deployment process (e.g., AI workflow process 600) consistent with embodiments of the present disclosure is provided. AI workflow process 600 may include enabling (602) a user, via an AI workbench, to create an AI workflow, converting (604) the AI workflow into an executable computational representation, and performing (606) data collection, data processing, and data analysis for the AI workflow. AI workflow process 600 may further include developing (608) one or more visualization tools for the AI workflow, developing (610) a UI for the AI workflow, selecting (612) one or more machine-learning (ML) models to be used in the AI workflow, and deploying (614) the one or more selected ML models, via the MLOps unit, in a network environment. AI workflow process 600 may also critically include developing (616) a set of rules for interpreting results generated for each ML model of the one or more selected ML models. At this point AI workflow process 600 may have generated a viable end-product; however, this end-product may be further improved by retraining (618) the one or more ML models previously deployed in the AI workflow, and then by reintegrating (620) the retrained ML models into the AI workflow.

Enabling (602) a user, via an AI workbench, to create an AI workflow may refer to the no-code UI, specifically the dragging and dropping of components on a workflow canvas, and the plain language instructions that may be received and translated by the natural language processing (NLP) functionality. Converting (604) the AI workflow into an executable computational representation may refer to the backend processing provided by the MLOps unit in conjunction with one or more large language models (LLMs). More specifically, natural language instructions may be processed using one or more specialized LLMs configured to translate user intent into executable code or configuration parameters. These LLMs may be fine-tuned on a dataset of AI operations and programming concepts to ensure accurate interpretation of user instructions.

In some embodiments, the codified workflow created by the user, may become an executable computational representation. The LLMs or ML models that facilitate this conversion may be described by the user in the workflow. But once described and published, that workflow may become a stand-alone computer unit that may be distributed amongst the computer units available for performing tasks, and operates as its own entity capable of all of the scaling properties and such mentioned in this disclosure,

In some embodiments, performing (606) data collection, data processing, and data analysis for the AI workflow may be considered separately. During the data collection process, the AI workbench may first specify the desired data sources, then add a collection process, and finally, the AI workbench may establish a data microservice, i.e., a small, self-contained, reusable service that is responsible for handling a specific data-related function within an AI workflow. This data microservice may be deployed as an independent unit and may be reused across workflows, scaled independently, and integrated into distributed architectures. For data processing, the AI workbench may first define a set of rules for processing the data, then develop one or more processing algorithms, and finally establish a transformation microservice. The transform microservice may be a modular, independently deployable service configured to apply specific data transformations to input data as part of an AI workflow. This transform microservice may be responsible for modifying, enriching, or reshaping data, often as a preprocessing or engineering feature, and it may be integrated into the larger pipeline via an application programming interface (API) or by passing an internal message. For data analysis, the AI workbench may first define a set of goals or objectives and then develop an algorithm to achieve those goals. Lastly, the AI workbench may establish an analysis microservice. The analysis microservice may be a self-contained, deployable service that performs a specific analytical function on data, such as summarizing, profiling, interpreting, or statistically analyzing datasets or model outputs. The analysis microservice may expose this specific analytical function as an independent microservice that may be integrated into other workflows.

In some embodiments, developing (608) one or more visualization tools for the AI workflow, a user may provide details on how they envision the AI tool or application looking, then they may use the no-code UI to develop visualization tools that may generate the kind of user experience they envisioned. Developing (610) a UI for the AI workflow may include, first, defining the user interaction requirements for the AI workflow. For example, text-based or graphical. Then the user may use the no-code UI to develop a UI based on those requirements, and finally generate views to compare how the actual UI created performs relative to how the user intended for it to perform.

In some embodiments, selecting (612) one or more machine-learning (ML) models to be used in the AI workflow may begin by specifying what kinds of ML models may be best suited for the intended purpose of the AI workflow. Once the ML models are selected, the user may provide relevant data to train the ML model and develop a training methodology for the ML model. For example, the user may train the ML model using labeled input-output pairs, allowing the ML model to compare itself against a predetermined outcome. Alternatively, the user may train the ML model using unlabeled data to gauge its pattern recognition capabilities. Then, after actually performing the training, the user may save the created model training pipeline to the AI workbench for deployment.

In some embodiments, deploying (614) the one or more selected ML models may include first defining deployment requirements, for example, by considering the intended user group and determining the scale of the deployment, such as cloud, edge, or on-premises. Then, the user may develop a deployment strategy based on the use case, environment, performance requirements, cost constraints, and other relevant factors. Then, after deploying the ML model, the user may use the AI workbench to generate model serving definitions, i.e., create configuration and infrastructure metadata required to expose a trained model as a service that may accept inputs and return predictions.

In some embodiments, developing (616) a set of rules for interpreting the results generated for each ML model may include, first, specifying one or more interpretation goals. The goal may be anything, for example, determining the suitability of an organ donor. The user may then use the AI workbench to develop one or more methods for interpreting the results. Consider, for example, if the output of the ML model measured the amount of iron present in the donor's blood. One possible method for interpreting the results may be to categorize the output results into different tiers of suitability based on predefined numerical ranges (e.g., “viable”—output>X, “non-viable”—output<Y, and “ideal”—Y>output<X). Finally, after the goals and methodology are determined, the ML model may be reintegrated with the rest of the workflow.

In some embodiments, AI workflow process 600 may further improve an AI workflow by re-training (618) one or more of the ML models initially selected. Unlike the initial selection and training process (612), the intended purpose of the AI workflow may already be known, and a training methodology for the ML model may already exist. A model training pipeline may have been previously created and saved to the AI workbench for deployment. As such, the re-training (618) process may only require the selected ML model to be run through the saved model training pipeline. Optionally, the user may provide a new batch of relevant data for the ML model to work through. Then the re-trained ML model may be reintegrated (620) with the AI workflow.

In some embodiments, the AI workbench may bridge the gap between non-technical users and advanced AI capabilities, and democratize AI development while maintaining the robustness and scalability required for enterprise-grade applications. Every workflow or app developed by a non-technical user may be automatically instantiated with a robust and feature-rich backing, comprised of model serving, model training, and tuning pipelines, workflow hosting, elegant logging and monitoring, annotation interfaces for guiding improvements, debugging overviews for deep oversight of every step of the information flow through the system, and careful resource and monetary cost estimation and control. The AI workbench may be a first-of-its-kind system, enabling both advanced technical users and non-technical users to develop powerful workflows or work more efficiently together.

In some embodiments, the no-code UI may be built using modern web technologies to provide a responsive and interactive user experience. The workflow editor may utilize a graph-based data structure to represent the connections between different AI components. In some embodiments, the server hosting the no-code UI may manage the execution of workflows, coordinate communication between components, and interface with the MLOps (machine learning operations) backend.

In some embodiments, behind the no-code UI, the MLOps backend may automatically handle complex tasks required to operationalize AI workflows. Tasks that may include setting up monitoring systems to track model performance and data drift, creating and managing training pipelines for continuous model improvement, and deploying and scaling endpoints to serve the AI models efficiently. The MLOps backend may also handle model versioning, lineage tracking, and rollback capabilities for AI models to ensure reproducibility and auditability. Additionally, it may log and organize machine learning experiments, including hyperparameters, metrics, and artifacts, and facilitate the deployment and scaling of models for inference in production environments.

In some embodiments, the MLOps backend may also provide continuous monitoring of model performance and data distributions to detect when models need retraining, tools and interfaces for efficient data labeling and annotation to support supervised learning tasks, automated systems for regular model retraining based on new data or detected drift, and orchestration and monitoring of model training processes across distributed computing resources. Further, the MLOps backend may provide systems for efficiently ingesting, transforming, and loading data from various sources into formats suitable for ML workflows, automated machine learning capabilities for model selection, hyperparameter tuning, and feature engineering, efficient management and execution of computational tasks across available resources, and cost tracking and estimation, paired with deep oversight of every step in any workflow.

In some embodiments, the UI may be configured to be highly scalable and may be deployed in various environments, including cloud deployments that may support major providers like AWS, Azure, and GCP, on-premises installations for organizations with strict data security requirements, or edge computing scenarios for resource-constrained or disconnected environments. The UI may include features for creating and managing team-based workflows. Users may collaborate on workflows, share components, and manage access permissions. The UI may also provide version control capabilities, allowing users to track changes, roll back to previous versions, and manage different iterations of workflows.

In some embodiments, the UI platform may support integration with external data sources and APIs, allowing users to incorporate real-time data feeds, database connections, and third-party services into their AI workflows. To promote trust and understanding in AI decisions, the UI may also include features that help users interpret model outputs, understand feature importance, and trace decision paths in complex workflows. In scenarios where data is not centralized due to privacy or regulatory concerns, the UI may support federated learning that allows models to be trained across multiple decentralized edge devices or servers holding local data samples, without exchanging them.

In some embodiments, the MLOps backend may be built on a microservices architecture, leveraging containerization and orchestration technologies to ensure scalability and facilitate easy deployment across various environments. Model serving may be handled by optimized inference engines to ensure high-performance execution of AI models. The UI platform may support both real-time inference for low-latency applications and batch processing for high-throughput scenarios. Data pipelines may be managed using stream processing technologies (e.g., Apache Kafka, Apache Flink) to handle large-scale data ingestion and preprocessing efficiently.

The AI workbench may represent a significant advancement in the field of AI development and deployment. By combining a no-code interface with natural language programming, the UI may enable non-technical users to create sophisticated AI applications that were previously only possible for skilled data scientists and ML (machine learning) engineers. The UI platform may provide a comprehensive solution, spanning from workflow creation to deployment and monitoring, thereby streamlining the entire AI development lifecycle and reducing the need for multiple disparate tools. The ability to integrate various types of AI models and deploy them in different environments may make the UI adaptable to a wide range of use cases and operational requirements, from small-scale experiments to large-scale production systems. The intuitive interface and automated backend may allow for quick iteration and deployment of AI solutions, significantly reducing development time and accelerating innovation. By abstracting away the technical complexities, the UI may address the shortage of AI expertise in many organizations, allowing domain experts to directly leverage AI capabilities without extensive training in data science or machine learning. These innovations position the AI Workbench as a transformative tool in the AI landscape, with potential applications across multiple industries, including defense, healthcare, finance, manufacturing, and more. By lowering the barriers to AI adoption and streamlining the development process, this invention has the potential to accelerate the integration of AI technologies into various sectors, driving innovation and efficiency.

The AI Workbench may represent a significant advancement in AI development and deployment. Its key innovations may include the democratization of AI through its no-code interface and natural language programming, providing an end-to-end solution from workflow creation to deployment and monitoring, flexibility to integrate various AI models and deploy in different environments, enabling rapid prototyping and deployment of AI solutions, and bridging the AI skills gap by abstracting away technical complexities. These innovations position the AI Workbench as a transformative tool in the AI landscape, with potential applications across multiple industries, including defense, healthcare, finance, and more.

The terminology used herein is for the purpose of describing particular embodiments and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

Although a few example embodiments have been described in detail above, those skilled in the art will readily appreciate that many modifications are possible in the example embodiments without materially departing from the scope of the present disclosure, as described herein. Accordingly, such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail, and a screw may be equivalent structures. It is the express intention of the applicant not to invoke 35 U.S.C. § 112, paragraph (f) for any limitations of any of the claims herein, except for those in which the claim expressly uses the words ‘means for’ or ‘step for’ together with an associated function.

Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
enabling a user, via an artificial intelligence (AI) workbench, to create an AI workflow;
converting the AI workflow into an executable computational representation;
performing data collection, data processing, and data analysis for the AI workflow;
developing one or more visualization tools for the AI workflow;
developing a UI for the AI workflow;
selecting one or more machine-learning (ML) models to be used in the AI workflow; and
developing a set of rules for interpreting results generated for each ML model of the one or more selected ML models.

2. The computer-implemented method of claim 1, wherein the AI workbench is a full-stack platform configured to provide end-to-end functionality from a front-end user interface to a back-end combination of infrastructure and programming logic.

3. The computer-implemented method of claim 2, wherein the AI workbench includes a no-code user interface (UI) configured to allow users without coding skills to produce customized AI tools, and to perform rapid prototyping without software development cycles.

4. The computer-implemented method of claim 3, wherein the no-code UI includes a workflow canvas configured to allow users to select and reorganize one or more modular components when creating the AI workflow, and a natural language programming (NLP) interface configured to receive and translate user-generated text-based, non-coded instructions defining a set of operational behaviors for each modular component of the one or more modular components selected for the AI workflow into machine-executable code-based instructions.

5. The computer-implemented method of claim 4, wherein the one or more modular components are selected from a set of different component types, wherein the set of different component types includes at least:
a data input component configured to receive input data;
a pre-processing component configured to clean, reformat, encrypt, or transform input data;
a model component configured to run one ML model from a set of different ML models;
a logic-control component configured to implement one or more logic commands, including at least if-else statements, filtering, branching, and looping;
a data output component configured to send output data to one output format from a set of different output formats;
a visualization component configured to display intermediate results or final results in one display format from a set of different display formats;
an annotation component configured to allow users to manually enter or modify labels or results; and
a monitoring component configured to collect and display performance metrics in one display format from the set of different display formats.

6. The computer-implemented method of claim 4, wherein the NLP interface includes one or more large language models (LLMs) trained in a wide variety of topics, including at least:
machine learning concepts;
model application programming interfaces (APIs);
data transformations;
data serialization formats; and
workflow schema templates.

7. The computer-implemented method of claim 4, wherein the workflow canvas includes:
a debugging window configured to provide oversight of every step of the information flow through the AI workflow; and
a live-preview window configured to provide real-time rendering of the AI workflow while user changes are actively being made on the workflow canvas.

8. The computer-implemented method of claim 2, wherein the AI workbench includes a machine-learning operations (MLOps) unit configured to:
deploy ML models selected for the AI workflow;
trigger model retraining for ML models selected for the AI workflow;
monitor and report on performance metrics for the AI workflow; and
perform versioning and generate audit trails for the AI workflow.

9. The computer-implemented method of claim 8, further including:
deploying the one or more selected ML models, via the MLOps unit, in a network environment;
retraining the one or more ML models previously deployed in the AI workflow; and
reintegrating the retrained ML models into the AI workflow.

10. The computer-implemented method of claim 2, wherein the AI workbench is configured to be scalably deployed in a plurality of network environments, including at least: cloud networks, on-premises networks, and edge-computing networks.

11. The computer-implemented method of claim 1, wherein the AI workflow includes an AI-powered assistant configured to recommend templates, provide contextual help, make suggestions, and guard against common misconceptions held by users when implementing machine learning processes.

12. A computer program product residing on a non-transitory computer readable medium having a plurality of instructions stored thereon which, when executed by a processor, cause the processor to perform operations comprising:
enabling a user, via an artificial intelligence (AI) workbench, to create an AI workflow;
converting the AI workflow into an executable computational representation;
performing data collection, data processing, and data analysis for the AI workflow;
enabling a user, via the AI workbench, to develop one or more visualization tools for the AI workflow;
enabling a user, via the AI workbench, to develop a UI for the AI workflow;
enabling a user, via the AI workbench, to select one or more machine-learning (ML) models to be used in the AI workflow; and
enabling a user, via the AI workbench, to develop a set of rules for interpreting results generated for each ML model of the one or more selected ML models.

13. The computer program product of claim 12, wherein the AI workbench is a full-stack platform configured to provide end-to-end functionality from a front-end user interface to a back-end combination of infrastructure and programming logic.

14. The computer program product of claim 13, wherein the AI workbench includes a no-code user interface (UI) configured to allow users without coding skills to produce customized AI tools, and to perform rapid prototyping without software development cycles.

15. The computer program product of claim 14, wherein the no-code UI includes:
a workflow canvas configured to allow users to select and reorganize one or more modular components when creating the AI workflow; and
a natural language programming (NLP) interface configured to receive and translate user-generated text-based, non-coded instructions defining a set of operational behaviors for each modular component of the one or more modular components selected for the AI workflow into machine-executable code-based instructions.

16. An artificial intelligence (AI) workbench system hosted on one or more servers connected to a scalable network, comprising:
a no-code user interface (UI) configured to allow users without coding skills to produce customized artificial intelligence (AI) tools, and to perform rapid prototyping without software development cycles; and
a machine-learning operations (MLOps) unit configured to:
deploy ML models selected for the AI workflow,
trigger model retraining for ML models selected for the AI workflow,
monitor and report on performance metrics for the AI workflow and perform versioning and generate audit trails for the AI workflow.

17. The AI workbench system of claim 16, wherein the no-code UI includes:
a workflow canvas configured to allow users to select and reorganize one or more modular components when creating the AI workflow; and
a natural language programming (NLP) interface configured to receive and translate user-generated text-based, non-coded instructions defining a set of operational behaviors for each modular component of the one or more modular components selected for the AI workflow into machine-executable code-based instructions.

18. The AI workbench system of claim 17, wherein the one or more modular components are selected from a set of different component types, wherein the set of different component types includes at least:
a data input component configured to receive input data;
a pre-processing component configured to clean, reformat, encrypt, or transform input data;
a model component configured to run one ML model from a set of different ML models;
a logic-control component configured to implement one or more logic commands, including at least if-else statements, filtering, branching, and looping;
a data output component configured to send output data to one output format from a set of different output formats;
a visualization component configured to display intermediate results or final results in one display format from a set of different display formats;
an annotation component configured to allow users to manually enter or modify labels or results; and
a monitoring component configured to collect and display performance metrics in one display format from the set of different display formats.

19. The AI workbench system of claim 17, wherein the NLP interface includes one or more large language models (LLMs) trained in a wide variety of topics, including at least:
machine learning concepts;
model application programming interfaces (APIs);
data transformations;
data serialization formats; and
workflow schema templates.

20. The AI workbench system of claim 16, further including an AI-powered assistant configured to recommend templates, provide contextual help, make suggestions, and guard against common misconceptions held by users when implementing machine learning processes.
